(19) United States
(12) Patent Application Publication
(10) Pub. No.: US 2007/0190849 A1
(43) Pub. Date: Aug. 16, 2007

(54) Lamp unit

(75) Inventors: Masaya Yamamoto, Aichi (JP); Toshimasa Yoshigi, Shizuoka (JP); Yasuharu Kondo, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/647,190

(22) Filed: Dec. 29, 2006

(30) Foreign Application Priority Data
Feb. 15, 2006 (JP) 2006-038588

(51) Int. Cl. H01R 11/00

(52) U.S. Cl. 439/505

(57) ABSTRACT

The lamp unit includes: a plurality of electric bulbs; a case which receives a plurality of the electric bulbs and is mounted to a mount base; a plurality of electric bulb-applied connectors attached to the respective electric bulbs; a gathering connector attached to a mounting part of the case, on which mounting part the case is mounted to the mount base; and electric wires for connecting the electric bulb-applied connectors to the gathering connector, wherein the mounting part of the case has a watertight structure and the gathering connector is a waterproof connector.

### BACKGROUND OF THE INVENTION

(1) Field of the Invention

The present invention relates to a lamp unit such as a headlamp of a motor vehicle as a mobile unit.

(2) Description of the Related Art

So far, various lamp units (for example, see Japanese Patent Publication No. 3454694) have been used as a headlamp of a motor vehicle. A lamp unit shown in Japanese Patent Publication No. 3454694 includes a plurality of electric bulbs (i.e. light bulbs), a plurality of socket plugs to be connected to the respective electric bulbs, a case to be attached to a mount such as a vehicle body of the motor vehicle for receiving the electric bulbs and so on, and a wiring harness for connecting the socket plugs and electric bulbs to an electric source mounted on the vehicle body of the motor vehicle.

The socket plug is attached to the case. The wiring harness includes a plurality of electric bulb-applied connectors coupling with the socket plugs, gathering connectors coupling with connectors of a different wiring harness mounted on the vehicle body of the motor vehicle, and electric wires for connecting the electric bulb-applied connectors to the gathering connectors. The electric wires are arranged, for example, in an engine room of the motor vehicle. Once the electric bulb-applied connector and the socket plug are coupled with each other, they constructs a waterproof connector which maintains a watertight characteristic between them.

As for the lamp unit, when the connectors of the wiring harness to be mounted on a vehicle body couples with the gathering connectors attached to the vehicle body, a desired electric power is supplied to the electric bulbs so as to light up the electric bulbs.

However, as for the lamp unit shown in Japanese Patent Publication No. 3454694, since the electric wires of the wiring harness are mounted in the vehicle body such as in an engine room of the motor vehicle, therefore man-hour required to mount the lamp unit on the vehicle body of the motor vehicle tends to increase. Further, since the socket plug and the electric bulb-applied connector construct a waterproof connector as described above, therefore the component number of the socket plugs and the electric bulb-applied connectors tends to increase, causing a cost-up of the lamp unit.

### SUMMARY OF THE INVENTION

It is therefore an objective of the present invention to solve the above problem and to provide a lamp unit which can restrict labor hour required to mount the lamp unit to a mount.

In order to attain the above objective, the present invention is to provide a lamp unit including:

a plurality of electric bulbs;

a case which receives a plurality of the electric bulbs and is mounted to a mount base;

a plurality of electric bulb-applied connectors attached to the respective electric bulbs;

a gathering connector attached to a mounting part of the case, on which mounting part the case is mounted to the mount base; and

electric wires for connecting the electric bulb-applied connectors to the gathering connector,

wherein the mounting part of the case has a watertight structure and the gathering connector is a waterproof connector.

With the construction described above, the gathering connector is attached to the case and therefore, the electric wires that connect the electric bulb-applied connectors and the gathering connector to each other are arranged in the case. Since the mounting part of the case has a watertight structure, therefore it is not necessary to make each electric bulb-applied connector have a watertight structure. Further, since the gathering connector is a waterproof connector, therefore liquid such as water can be prevented from entering into a connection part between the electric bulb and the electric wire even if each electric bulb-applied connector is not a waterproof connector.

With the construction described above, since the electric wires that connect the electric bulb-applied connectors and the gathering connector to each other are arranged in the case, therefore it is not necessary to arrange the electric wires on a vehicle body of a motor vehicle. Therefore, the lamp unit can be a module. That is, by connecting a wiring harness, which is to be mounted on a mount base, to the gathering connector, the lamp unit can be mounted on the mount base, thereby restricting labor hour required to mount the lamp unit on the mount base.

Further, since it is not necessary to make each electric bulb-applied connector have a watertight structure, therefore the number of components of the electric bulb-applied connector can be restricted, that is, the number of components of the lamp unit itself can be restricted and therefore, a cost-up of the lamp unit can be prevented from occurring.

Furthermore, since liquid such as water can be prevented from entering into a connection part between the electric bulb and the electric wire even if each electric bulb-applied connector is not a waterproof connector, therefore the number of components of the electric bulb-applied connector can be securely restricted, that is, the number of components of the lamp unit itself can be securely restricted.

Preferably, the electric bulb-applied connectors and the gathering connector include respective pressure welding terminals pressure-welding to the electric wires.

With the construction described above, since each connector is a so-called pressure welding connector having a pressure welding terminal, therefore the electric wires can be collectively pressure-welded to the pressure welding terminals of a plurality of the connectors. Therefore, man-hour required to attach the connectors to the electric wires can be reduced. That is, man-hour required to assemble the lamp unit can be reduced.

Preferably, one end of the electric wire is attached to the electric bulb-applied connector, while an opposite end of the electric wire is attached to the gathering connector.

With the construction described above, since the connectors are attached to both ends of the electric wire, therefore the electric wire can securely connect the connectors. Therefore, the electric bulbs of the lamp unit and electronic instruments mounted on the mount base can be securely connected to each other.

Preferably, the electric wire is a flat circuit body including a plurality of conductors and a coating that coats the conductors, wherein a plurality of the electric bulb-applied connectors and the gathering connector are arranged along a longitudinal direction of the flat circuit body having a distance therebetween.

With the construction described above, the connectors are arranged just like in a series by the flat circuit body. Therefore, the flat circuit bodies are prevented from being locked together when the flat circuit bodies are arranged. Therefore, man-hour required to assemble the lamp unit can be reduced.

### BRIEF DESCRIPTION OF THE DRAWINGS

FIG. 1 illustrates a headlamp according to a preferred embodiment of the present invention;

FIG. 2 illustrates a construction of a wiring harness of the headlamp shown in FIG. 1;

FIG. 3 is an enlarged cross sectional view of a part III shown in FIG. 1;

FIG. 4 is an exploded perspective view of an electric bulb-applied connector of the headlamp shown in FIG. 1;

FIG. 5 is a perspective view of a gathering connector of the headlamp shown in FIG. 1;

FIG. 6 is a cross sectional view taken along VI-VI line in FIG. 5;

FIG. 7 illustrates a headlamp according to another preferred embodiment of the present invention;

FIG. 8 is a perspective view of a wiring harness of a headlamp shown in FIG. 7; and

FIG. 9 is a plan view of the wiring harness shown in FIG. 8.

### DESCRIPTION OF THE PREFERRED EMBODIMENTS

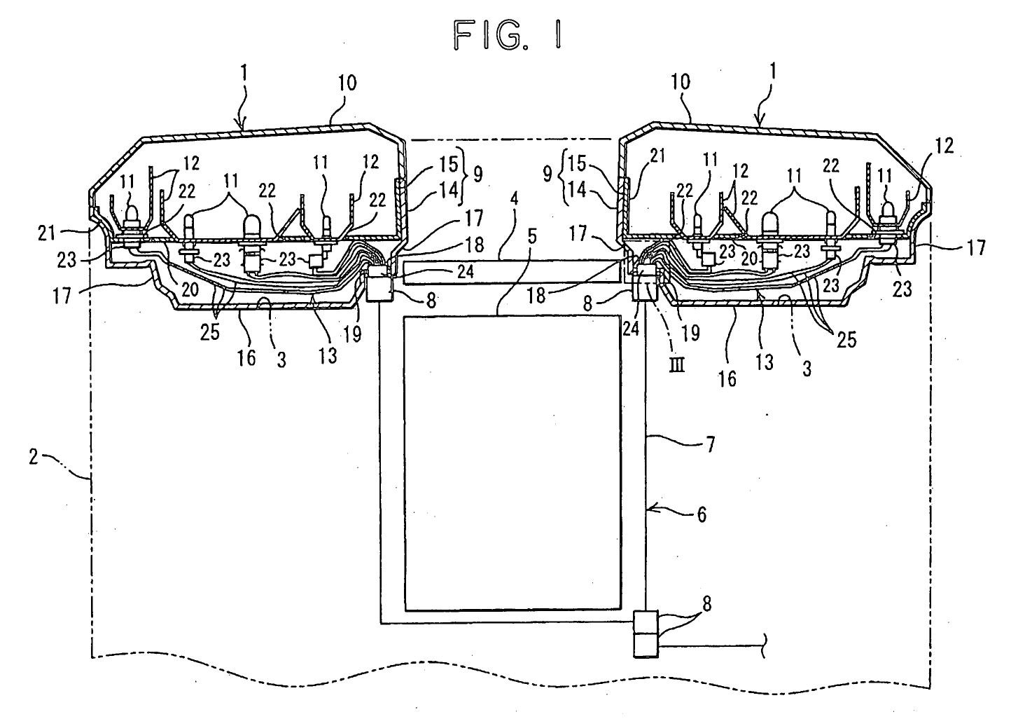

In the following, a headlamp as a lamp unit according to a preferred embodiment of the present invention will be explained with reference to FIGS. 1-6.

As shown in FIG. 1, a headlamp 1 as a lamp unit according to a preferred embodiment of the present invention is mounted on a vehicle body 2 of a motor vehicle as a mobile unit. The vehicle body 2 consists of sheet metal and so on. The vehicle body 2 includes a mount portion 3, on which the headlamp 1 is mounted, at the front part of the motor vehicle. The vehicle body 2 corresponds to the mount base.

As shown in FIG. 1, a radiator 4 and an engine 5 are provided at the middle of the front part of the vehicle body 2 in the width direction thereof. The vehicle body 2 includes a wiring harness 6, which connects the headlamp 1 to a power source such as a battery or a generator. The wiring harness 6 includes electric wires 7 and connectors 8 attached to ends of the electric wires 7.

As shown in FIG. 1, the headlamp 1 includes a case 9, lenses 10, a plurality of electric bulbs 11, a plurality of reflectors 12 and wiring harness 13. The case 9 includes an outer case 14 and inner case 15.

The outer case 14 is made of synthetic resin such as polypropylene and includes: a mounting wall 16 as the mounting part to be attached to the mount portion 3; and a peripheral wall 17 standing up from an outer edge of the mounting wall 16. The mounting wall 16 of the outer case 14 is placed on the mount portion 3 of the vehicle body 2 to be mounted on the mount portion 3.

The mounting wall 16 includes a through hole 18 for letting a gathering connector 24 (explained later on) pass therethrough. As shown in FIG. 3, a ring-shaped packing 19 maintains a watertight characteristic between the through hole 18 and the gathering connector 24. The packing 19 is made of resiliently deformable synthetic resin such as rubber as resilient material. Thus, the mounting wall 16 has a watertight structure which prevents liquid such as water from passing therethrough.

The inner case 15 is arranged inside the outer case 14. The inner case 15 includes: a parallel wall 20 arranged in parallel with the mounting wall 16 having a distance therebetween; and a wall 21 which stands up from an outer edge of the parallel wall 20 and placed on an inner surface of the peripheral wall 17 of the outer case 14. The parallel is wall 20 includes a through hole 22 for letting the reflector 12 pass therethrough. The through hole 22 facilitates a work upon replacing the electric bulb 11.

The lens 10 is made of transparent material and formed in a plate-shape. The lens 10 is welded to an edge of the peripheral wall 17 of the outer case 14, said edge being situated away from the mounting wall 16, thereby the lens 10 is attached to the outer case 14. When the lens 10 is attached to the outer case 14, the lens 10 maintains a watertight characteristic between the lens 10 and the outer case 14. When the lens 10 is attached to the outer case 14, the lens 10 closes a space within the case 9.

A plurality of the electric bulbs 11 are received in the inner case 15 and arranged within a space surrounded by the inner case 15 and the lens 10. In an example shown in the figure, four electric bulbs are provided. One of these four bulbs is for a high beam, another is for a low beam, the third is for a hazard, the fourth is for indicating a direction.

The reflector 12 reflects light emitted from the electric bulb 11 and guides the light ahead of the motor vehicle through the lens 10. A surface of the reflector 12 is a mirror-plane like plate-shaped. The reflector 12 is received in the outer case 14, passes through the through hole 22 of the inner case 15, and arranged within a space surrounded by the case 9 and the lens 10. The reflector 12 is attached to a base of the electric bulb 11.

In an example shown in the figure, three reflectors 12 are provided. One of the three reflectors 12 is attached to a base of the electric bulb 11 for a high-beam and the electric bulb 11 for a hazard. Another reflector 12 is attached to a base of the electric bulb 11 for a low beam. The third reflector 12 is attached to a base of the electric bulb 11 for indicating a direction.

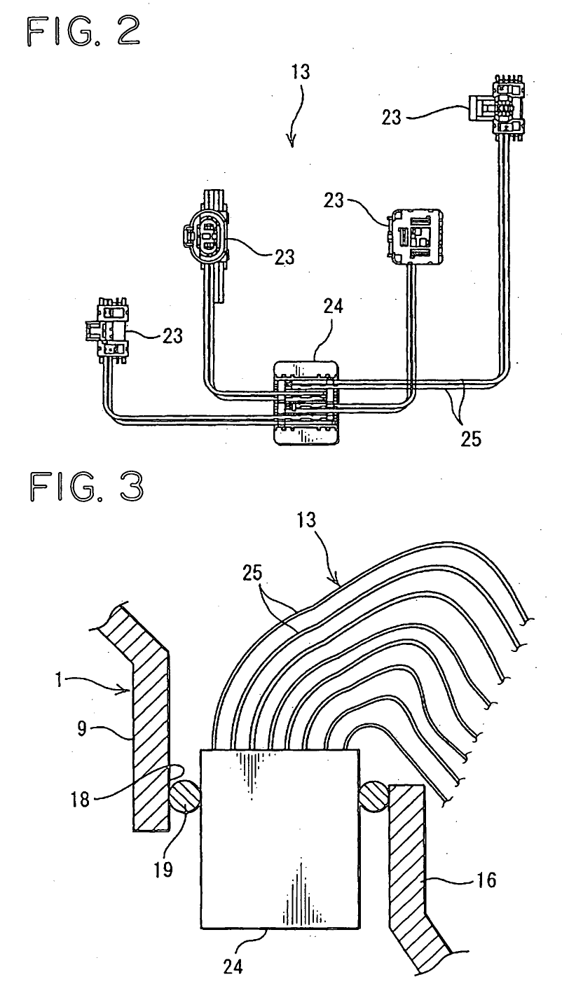

As shown in FIGS. 1 and 2, the wiring harness 13 includes: a plurality of electric bulb-applied connectors 23, the gathering connector 24 which is to be coupled with the connectors 8 of the wiring harness 6 mounted on the vehicle body 2 of the motor vehicle; and electric wires 25 for connecting the electric bulb-applied connectors 23 to the gathering connector 24. The number of the electric bulb-applied connectors 23 is the same as that of the electric bulbs 11. One electric bulb-applied connector 23 is connected to a corresponding electric bulb 11. The electric bulb-applied connectors 23 are received in the case 9 and arranged within a space surrounded by the case 9 and the lens 10.

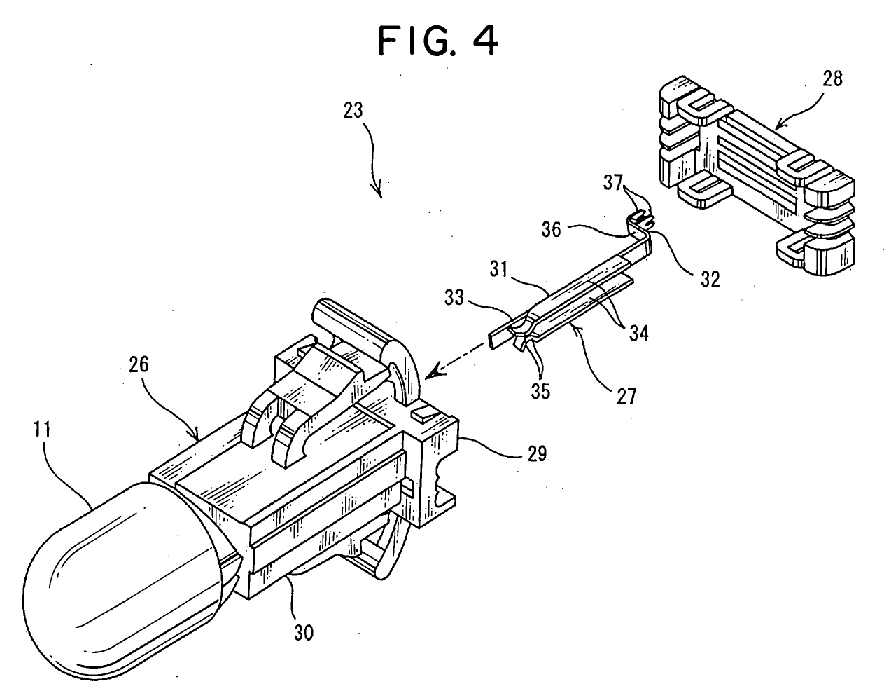

A plurality of the electric bulb-applied connectors 23 have approximately the same construction. Therefore, for an example, the electric bulb-applied connector 23, to which the electric bulb 11 for a hazard is attached, is explained in the following. As shown in FIG. 4, the electric bulb-applied connector 23 includes a connector housing 26, pressure welding terminal 27 and a cover 28.

The connector housing 26 is made of electrically insulating synthetic resin and includes a tube-shaped electric wire-receiving part 29 and a terminal-receiving part 30 standing up from the electric wire-receiving part 29. The electric wire-receiving part 29 receives the electric wires 25 therein and positions a pressure welding blade 37 (explained later on) of the pressure welding terminal 27 inside. The terminal-receiving part 30 is formed in a tube-shape and receives mainly an electric contact part 31 (explained later on) of the pressure welding is terminal 27 therein. The base 11 of the electric bulb 11 is inserted in the terminal-receiving part 30.

A pair of the pressure welding terminals 27 are provided. The pressure welding terminal 27 is made of sheet metal and includes the electric contact part 31 and an electric wire connecting part 32 which continues to the electric contact part 31. The electric contact part 31 integrally includes a bottom plate 33, a pair of side plates 34 standing up from both edges in the width direction of the bottom plate 33, and a resilient deformable piece 35 formed at an end of the side plate 34.

The bottom plate 33 and the side plate 34 are formed in a plate-shape. The resilient deformable piece 35 continues to the corresponding end of the side plate 34 and arranged at an end of the terminal-receiving part 30, said end being situated away from the electric wire-receiving part 29, when the electric contact part 31 is received in the terminal-receiving part 30. The resilient deformable piece 35 nips the base of the electric bulb 11 inserted in the terminal-receiving part 30 therebetween so as to connect with the base of the electric bulb 11.

The electric wire connecting part 32 includes a bottom plate 36 for placing the electric wire and a pressure welding blade 37 standing up from the bottom plate 36 for placing the electric wire. The bottom plate 36 continues to an end of the bottom plate 33 of the electric contact part 31 in the proximity of the electric wire-receiving part 29 and bends by 90 degrees from the bottom plate 33. The bottom plate 36 is arranged at the bottom of the electric wire-receiving part 29. The pressure welding blade 37 stands up from the bottom plate 36 in a direction leaving the terminal-receiving part 30. The pressure welding blade 37 includes a slit into which the electric wire 25 is press-fitted. When the electric wire 25 is press-fitted into the slit, the pressure welding blade 37, i.e. the electric wire connecting part 32 cuts the coating of the electric wire 25 so as to connect with the core wire of the electric wire 25. Thus, the pressure welding blade 37, i.e. the electric wire connecting part 32 is pressure-welded to the electric wire 25.

The cover 28 is made of electrically insulating synthetic resin and formed in a flat plate-shape. The cover 28 is attached to the connector housing 26, i.e. to the electric wire-receiving part 29 closing the electric wire-receiving part 29.

As for the electric bulb-applied connector 23, the pressure welding terminal 27 is press-fit into the terminal-receiving part 30 from the electric wire-receiving part 29-side. Then, the resilient deformable piece 35 of the pressure welding terminal 27 is positioned within the terminal-receiving part 30 and the pressure welding blade 37 is positioned within the electric wire-receiving part 29. After the electric wire 25 is pressure-welded to the pressure welding blade 37, the cover 28 is attached to the electric wire-receiving part 29, thereby assembling the electric bulb-applied connector 23. Then, the base of the electric bulb 11 is press-fit into the terminal-receiving part 30, so that the base of the electric bulb 11 is nipped between the pair of the resilient deformable pieces 35, thereby electrically connecting the electric bulb 11 to the electric wire 25.

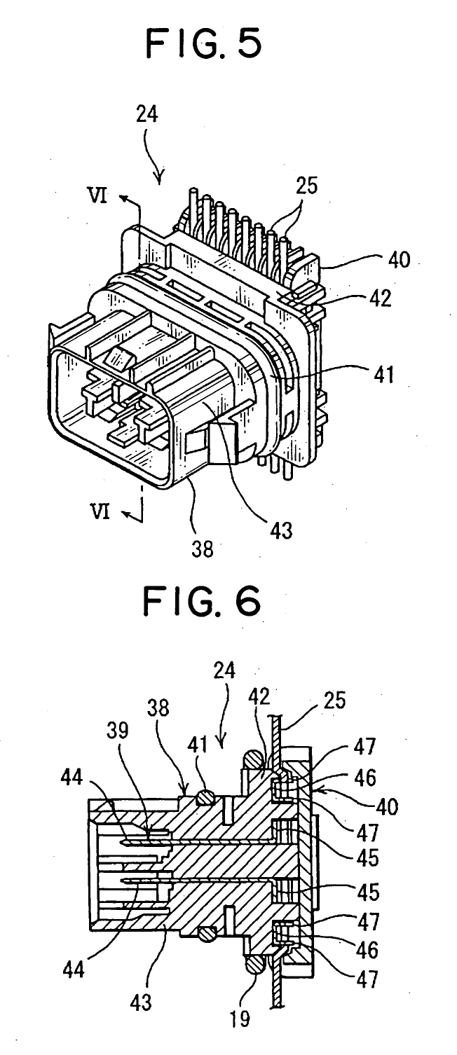

As shown in FIGS. 5 and 6, the gathering connector 24 includes a connector housing 38, pressure-welding terminal 39, cover 40 and a sealing member 41.

The connector housing 38 is made of electrically insulating synthetic resin and includes a tub-shaped electric wire-receiving part 42 and a terminal receiving part 43 standing up from the electric wire receiving part 42. The electric wire-receiving part 42 receives the electric wires 25 therein and positions a pressure welding blade 47 (explained later on) of a pressure welding terminal 39 inside. The terminal-receiving part 43 is formed in a tube-shape and receives mainly an electric contact part 44 (explained later on) of the pressure welding terminal 39 therein. The connector 8 of the wiring harness 6 is inserted in the terminal-receiving part 43. The terminal-receiving part 43 fits to the connector 8 of the wiring harness 6. The connector housing 38 passes into the through hole 18 of the outer case 14 and is attached to the mounting wall 16. The connector housing 38, i.e. the gathering connector 24 maintains a watertight characteristic between the connector housing 38 and the mounting wall 16.

A pair of the pressure welding terminals 39 are provided. The pressure welding terminal 39 is made of sheet metal and includes the electric contact part 44 and an electric wire connecting part 45 which continues to the electric contact part 44. The electric contact part 44 is received in the terminal-receiving part 43. The electric contact part 44 is formed in a flat plate-shape. The electric contact part 44 electrically mechanically connects with a terminal fitting of the connector 8 of the wiring harness 6.

The electric wire connecting part 45 includes a bottom plate 46 for placing the electric wire and a pressure welding blade 47 standing up from the bottom plate 46 for placing the electric wire. The bottom plate 46 continues to an edge of the electric contact part 44 in the proximity of the electric wire-receiving part 42 and bends by 90 degrees from the electric contact part 44. The bottom plate 46 is arranged at the bottom of the electric wire-receiving part 42. The pressure welding blade 47 stands up from the bottom plate 46 in a direction leaving the terminal-receiving part 43. The pressure welding blade 47 includes a slit into which the electric wire 25 is press-fitted. When the electric wire 25 is press-fitted into the slit, the pressure welding blade 47, i.e. the electric wire connecting part 45 cuts the coating of the electric wire 25 so as to connect with the core wire of the electric wire 25. Thus, the pressure welding blade 47, i.e. the electric wire connecting part 45 is pressure-welded to the electric wire 25.

The cover 40 is made of electrically insulating synthetic resin and formed in a flat plate-shape. The cover 40 is attached to the connector housing 38, i.e. to the electric wire-receiving part 42 closing the electric wire-receiving part 42.

The sealing member 41 is made of resiliently deformable synthetic resin such as rubber as resilient material and formed in a ring-shape. The sealing member 41 is attached to the connector housing 38 on a condition that the sealing member 41 lets the terminal-receiving part 43 of the connector housing 38 pass inside thereof. When the connector 8 couples with the connector housing 38, i.e. to the gathering connector 24, the sealing member 41 maintains a watertight characteristic between the connector 8 and the gathering connector 24.

As for the gathering connector 24, the pressure welding terminal 39 is press-fit into the terminal-receiving part 43 from the electric wire-receiving part 42-side. Then, the electric contact part 44 of the pressure welding terminal 3-9 is positioned within the terminal-receiving part 43 and the pressure welding blade 47 is positioned within the electric wire-receiving part 42. After the electric wire 25 is pressure-welded to the pressure welding blade 47, the cover 40 is attached to the electric wire-receiving part 42, thereby assembling the gathering connector 24.

Then, the packing 19 is attached to an outer periphery of the gathering connector 24, passes into the through hole 18 of the outer case 14, and is attached to the case 9. When the connector 8 of the wiring harness 6 is inserted into the terminal-receiving part 43, the connector 8 couples with the gathering connector 24. Then, the pressure welding terminal 39 connects the electric wire 25 to the terminal fitting, so that the gathering connector 24 electrically connects the electric bulb-applied connector 23, i.e. electric bulb 11 to an electric source and so on placed on the vehicle body 2.

The gathering connector 24 includes the sealing member 41 which maintains a watertight characteristic between the connector 8 of the wiring harness 6 and the gathering connector 24. That is, the gathering connector 24 is a so-called waterproof connector, which maintains a watertight characteristic between the waterproof connector and a mating connector so as to prevent liquid such as water from entering inside from between the waterproof connector and the mating connector, said mating connector being to be coupled with the waterproof connector.

The electric wire 25 is a so-called coated electric wire, which includes an electrically conductive core wire and an electrically insulating coating that coats the core wire, and is formed round in a section. The core wire includes at least one element wire made of metal such as copper. The coating is made of electrically insulating synthetic resin. One end of the electric wire 25 is pressure-welded to the pressure welding terminal 27 of the electric bulb-applied connector 23, while an opposite end of the electric wire 25 is pressure-welded to the pressure welding terminal 39 of the gathering connector 24, thereby connecting the electric bulb 11 to the electric wire 7 of the wiring harness 6. That is, the one end of the electric wire 25 is connected to the electric bulb-applied connector 23, while the opposite end of the electric wire 25 is connected to the gathering connector 24. Further, the electric wire 25 is arranged between the parallel wall 20 and the mounting wall 16 and placed on the parallel wall 20.

The connector 8 of the wiring harness 6 couples with the gathering connector 24, so that the headlamp 1 is mounted on the mount portion 3 of the vehicle body 2. Thereby, each electric bulb 11 is connected to a corresponding electronic instrument such as an electric source through the electric bulb-applied connector 23, electric wire 25 and gathering connector 24. When the headlamp 1 is used, a desired electric bulb 11 is turned on.

According to the preferred embodiment, since the gathering connector 24 is attached to the case 9, therefore the electric wires 25 for connecting the electric bulb-applied connectors 23 to the gathering connector 24 can be arranged within the case 9. Therefore, it is not necessary to arrange the electric wires 25 on the vehicle body 2 of the motor vehicle.

Therefore, the headlamp 1 can be a module. Since the connector 8 of the wiring harness 6, which is mounted on the vehicle body 2 of the motor vehicle, is coupled with the gathering connector 24, therefore each electric bulb 11 can be connected to, for example, an electric source. That is, by connecting the wiring harness 6, which is mounted on the vehicle body 2, to the gathering connector 24, the headlamp 1 can be connected to the vehicle body 2, thereby restricting labor hour required to mount the headlamp 1 on the vehicle body 2.

Since the mounting wall 16 of the case 9 has a watertight structure, therefore liquid such as water is prevented from entering into the case 9. Therefore, it is not necessary to make the electric bulb-applied connectors 23 be a waterproof connector. Therefore, the number of components of the electric bulb-applied connector 23 can be restricted, that is, the number of components of the headlamp 1 itself can be restricted and therefore, a cost-up of the headlamp 1 can be prevented from occurring.

Since the gathering connector 24 is a waterproof connector, therefore liquid such as water is prevented from entering into the case 9. Therefore, it is not necessary to make the electric bulb-applied connectors 23 be a waterproof connector in order to prevent liquid such as water from entering to a contact of the electric bulb 11 and so on.

Since the electric bulb-applied connectors 23 and the gathering connector 24 include the pressure-welding terminals 27 and 39, respectively, therefore after the pressure-welding terminals 27 and 39 are mounted on the respective connector housings 26 and 38, the electric wires 25 can be collectively pressure-welded to the pressure-welding terminals 27 and 39. Therefore, man-hour required to assemble the wiring harness 13 can be reduced. That is, man-hour required to assemble the headlamp 1 can be reduced.

Further, since the connectors 23 and 24 are attached to the respective ends of the electric wire 25, therefore the electric wire 25 can securely connects the connectors 23 and 24 to each other. That is, the electric bulb 11 in the headlamp 1 can be securely connected to an electronic instrument such as an electric source, which is mounted on the vehicle body 2 as the mount base.

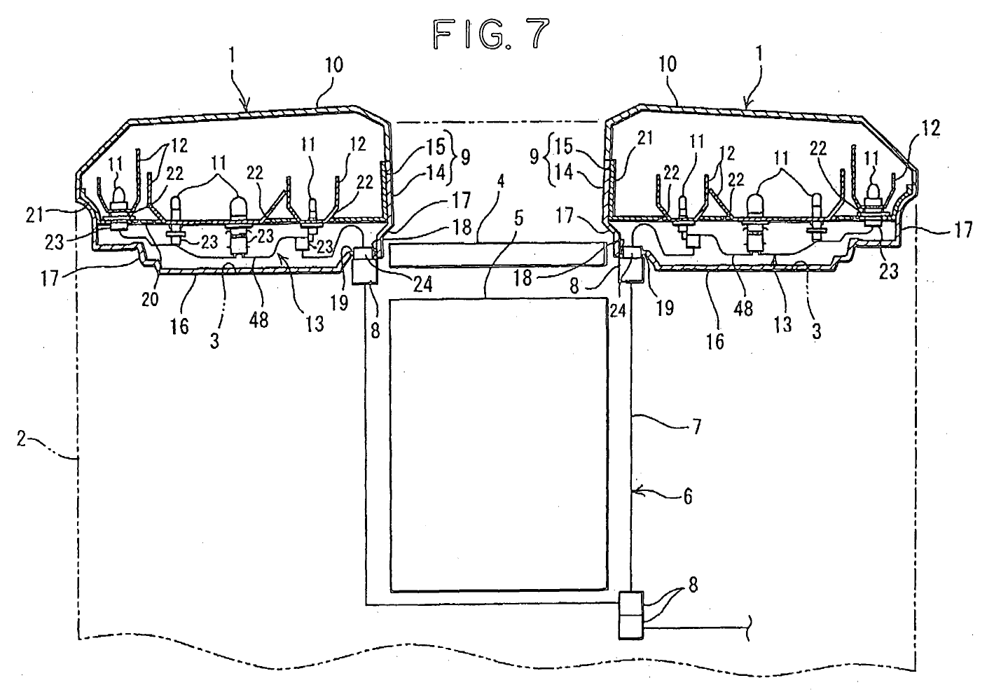

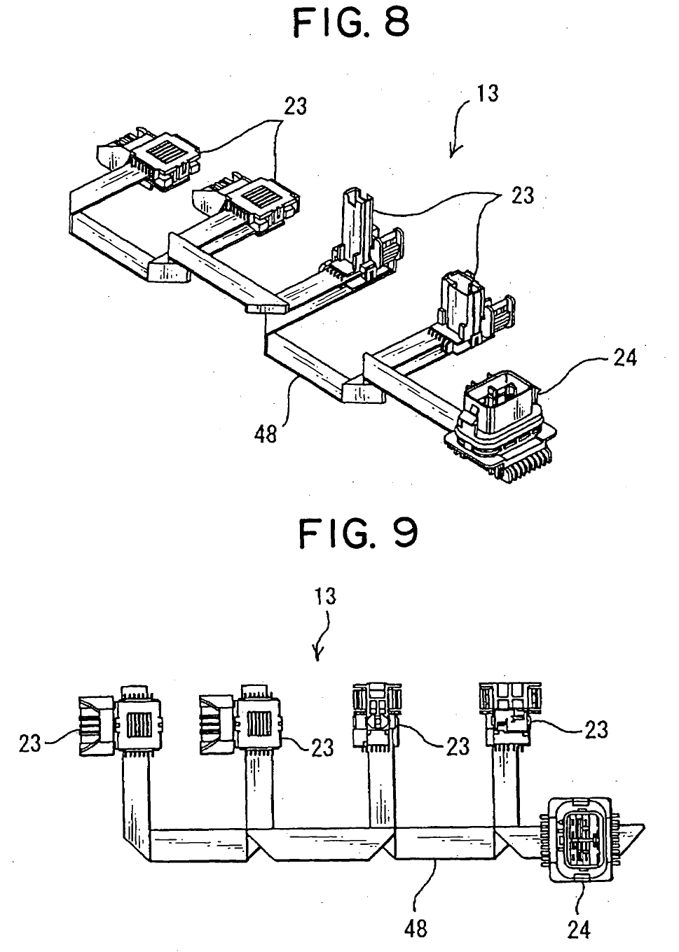

In the preferred embodiment described above, the so-called coated electric wire having a round shape in a section is used as the electric wire 25 that constitutes the wiring harness 13. However, instead, as shown in FIGS. 7-9, a flat circuit body such as a flexible flat cable (hereinafter, FFC) 48 may be used as the electric wire 25 that constitutes the wiring harness 13.

The FFC 48 includes a plurality of conductors and a pair of electrically insulating sheets for coating the conductors. The pair of the insulating sheets is a coating. The conductor has a rectangular shape in a section and has a belt-shape extending in a direction. A plurality of the conductors are arranged in parallel with each other having a distance therebetween. The insulating sheet has a slit formed between the conductors of the insulating sheet at a position where the insulating sheet is pressure welded to the pressure-welding terminals 27 and 39 of the connectors 23 and 24, so that the insulating sheet is pressure welded to the pressure welding blades 37, 47 of the pressure welding terminals 27, 39 like the electric wire 25.

As for the wiring harness 13 shown in FIGS. 7-9, the gathering connector 24 and a plurality of the electric bulb-applied connectors 23 are arranged having a distance therebetween along the longitudinal direction of the FFC 48. The connectors 23 and 24 appear to be arranged in series by the FFC 48. As for the wiring harness 13 shown in FIGS. 7-9, the FFC 48 is bent at an appropriate position.

As described above, in the present invention, the FFC 48 or a known belt-shaped flat circuit body such as a flexible printed circuit (FPC) may be used as the electric wire. The flat circuit body includes conductors arranged in parallel to each other and a flat coating that coats the conductors. The flat circuit body has a flat belt-shape as a whole.

In an example shown in FIGS. 7-9, the connectors 23 and 24 are arranged along the longitudinal direction of the FFC 48, i.e. the longitudinal direction of the wiring harness 13 having a distance therebetween. The connectors 23 and 24 appear to be arranged in series by the FFC 48. Therefore, when the wiring harness 13 is mounted, the FFCs 48 as the electric wires are prevented from being entangled with each other, thereby man hour required to mount the wiring harness 13, i.e. man-hour required to assemble the headlamp 1 can be reduced.

In the preferred embodiment described above, the headlamp 1 is explained as the lamp unit. However, the present invention can be applied to various lamp units such as a rearlamp or a lamp unit used in a room. Further, the present invention can also be applied to a lamp unit used in various articles besides a motor vehicle.

In the preferred embodiment described above, the connectors 23 and 24 are so-called pressure-welding connectors having the pressure-welding terminals 27 and 39, respectively. However, in the present invention, the electric bulb-applied connector 23 and the gathering connector 24 may be so-called crimp connectors each having a pressure-welding terminal.

The aforementioned preferred embodiments are described to aid in understanding the present invention and variations may be made by one skilled in the art without departing from the spirit and scope of the present invention.

What is claimed is:

1. A lamp unit comprising:
a plurality of electric bulbs;
a case which receives a plurality of the electric bulbs and is mounted to a mount base;
a plurality of electric bulb-applied connectors attached to the respective electric bulbs;
a gathering connector attached to a mounting part of the case, on which mounting part the case is mounted to the mount base; and
electric wires for connecting the electric bulb-applied connectors to the gathering connector,
wherein the mounting part of the case has a watertight structure and the gathering connector is a waterproof connector.

2. The lamp unit according to claim 1, wherein the electric bulb-applied connectors and the gathering connector include respective pressure welding terminals pressure-welding to the electric wires.

3. The lamp unit according to claim 1, wherein one end of the electric wire is attached to the electric bulb-applied connector, while an opposite end of the electric wire is attached to the gathering connector.

4. The lamp unit according to claim 2, wherein one end of the electric wire is attached to the electric bulb-applied connector, while an opposite end of the electric wire is attached to the gathering connector.

5. The lamp unit according to claim 1, wherein the electric wire is a flat circuit body including a plurality of conductors and a coating that coats the conductors, wherein a plurality of the electric bulb-applied connectors and the gathering connector are arranged along a longitudinal direction of the flat circuit body having a distance therebetween.

6. The lamp unit according to claim 2, wherein the electric wire is a flat circuit body including a plurality of conductors and a coating that coats the conductors, wherein a plurality of the electric bulb-applied connectors and the gathering connector are arranged along a longitudinal direction of the flat circuit body having a distance therebetween.
